(19) United States
(12) Patent Application Publication
(10) Pub. No.: US 2026/0206789 A1
(43) Pub. Date: Jul. 23, 2026

(54) COMPOSITION FOR FORMING A BEVERAGE

(71) Applicant: Koninklijke Douwe Egberts B.V., Utrecht (NL)

(72) Inventors: Maria Cielo Cantoni, Utrecht (NL); Vincent Jan Steenhof, Utrecht (NL)

(21) Appl. No.: 19/577,277

(22) Filed: Mar. 24, 2026

Related U.S. Application Data
(63) Continuation of application No. 17/799,907, filed on Feb. 17, 2021.

(30) Foreign Application Priority Data
Feb. 17, 2020 (GB) 2002150.7

(51) Int. Cl. A23F 5/40; A23C 11/02; A23F 5/38

(52) U.S. Cl. CPC A23F 5/405; A23C 11/02; A23F 5/38

(57) ABSTRACT

The present invention relates to a composition for forming a beverage, the composition comprising a mixture of powder ingredients, the ingredients comprising:
i) soluble coffee;
ii) a non-protein creamer; and
iii) a plant-based powder selected from one or more of oat powder, coconut powder, soy powder and almond powder;
wherein a ratio by weight of the non-protein creamer powder to plant-based powder is at least 1:3.

This disclosure relates to a composition for forming a beverage and, in particular, to an alternative to a dairy-based whitened coffee composition. The composition includes a plant-based powder as the protein source, rather than relying on dairy proteins.

A number of alternatives to dairy ingredients are well known. Particularly in recent years, consumers have been seeking out vegan products and the prevalence of different “milk” products, such as almond milk or soy milk, is increasing. These products are seen as desirable because they avoid dairy ingredients, and also because the products avoid the risks for some consumers associated with dairy ingredients and the allergens therein, such as lactose.

However, it is not a straight-forward matter to replace a milk powder ingredient in a beverage composition. In particular, there are difficulties associated with ensuring full product dissolution (i.e. avoiding sedimentation or separation), sufficient product whitening, desirable tastes and mouthfeel, as well as ensuring that the product quality is maintained. That is, while consumers may be seeking a non-dairy alternative to their cappuccino product, they still wish to ensure that the product resembles a conventional cappuccino and provides a similar experience. In addition, several potential alternative ingredients are associated with their own allergen issues.

Various approaches have already been taken to provide non-dairy beverage whitener- or creamer-containing compositions. In some of these approaches the manufacturer has relied upon small amounts of plant-based protein additives. Such small amounts are relatively easy to solubilise and have a limited impact on the product quality. In order to achieve suitable levels of protein in such products the manufactures often then use blends of different protein sources. However, the commercial message associated with such protein blends is unclear, since the product cannot be readily identified as, for example, an “almond cappuccino”.

Other approaches to provide such non-dairy beverages include providing a combined soluble product. That is, the manufacturer provides a spray- or freeze-dried product which has been obtained by drying a homogenised aqueous blend of the required ingredients. The protein ingredient is then held within an emulsion formed with the fat component of the creamer ingredient. This approach allows for good distribution of the non-dairy protein source and aids in the final dissolution and suspension of these ingredients. However, the manufacture of such products is complicated and not suitable in all circumstances.

CN104621311 relates to almond coffee which is characterized by comprising the following components in percentage by weight: 8-15 percent of instant coffee powder, 25-35 percent of non-dairy creamer, 30-50 percent of powdered sugar and 10-25 percent of almond meal. CN109043090 discloses a production technology of an oligosaccharide solid coffee beverage.

CN109864162 discloses an earthworm protein coffee beverage.

Accordingly, it is desirable to provide a composition for forming a beverage and a method for making the same which tackles at least some of the problems associated with the prior art or, at least, to provide a commercially viable alternative thereto.

In a first aspect there is provided a composition for forming a beverage, the composition comprising a mixture of powder ingredients, the ingredients comprising:
i) soluble coffee;
ii) a non-protein creamer; and
iii) a plant-based powder selected from one or more of oat powder, coconut powder, soy powder and almond powder;
wherein a ratio by weight of the non-protein creamer powder to plant-based powder is at least 1:3.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The disclosure relates to a composition for forming a beverage. That is, the disclosure relates to a composition which can be used to form a beverage on dissolution or dispersion in an aqueous medium (generally water or a milk). Typically, the composition is referred to as a coffee mix and, if sugar is present, as a 3-in-1 mix (i.e. coffee, creamer and sweetener). The composition is sold typically in a sachet or stickpack which is emptied by a consumer into their beverage receptacle. Other applications include beverage capsules, cartridges and filter pouches or pads for use in beverage preparation machines, and cups pre-loaded with the composition. On the addition of near-boiling water (i.e. 80-95° C.) a beverage is reconstituted. A typical serving will contain about 1.5 to 2 g of soluble coffee for reconstitution in 150 to 250 ml of water. Preferably the invention provides an individually packaged serving for forming a single beverage.

The composition comprises a mixture of powder ingredients. That is, the ingredients are each provided in a powder form and mixed together. Preferably the ingredients remain discrete such that, in principle, the ingredients could be separated by mechanical means, since the ingredients are not intimately formed or agglomerated/adhered together. This is advantageous since the ingredients can be prepared separately and simply mixed together, rather than requiring complex treatment steps or the contamination of expensive equipment with potential allergens. In one aspect discussed below, the dry blended mix can be granulated or agglomerated after forming the mixture to increase the solubility of the powder product. This is advantageous since it excludes complex upstream wet processing and contamination of allergens of these processes

By powder form it is meant that the ingredients are provided as particles and each will have its own particle-size distribution. By way of example, spray-dried coffee will typically have a mean particle size range of 300 microns to 2 mm, and freeze-dried coffee will typically have a mean particle size range of 1 to 3 mm.

The ingredients include soluble coffee. Soluble coffee powders are well known in the art. The best known examples are spray and freeze-dried coffee powders. These are made by drying concentrated coffee extracts and therefore a comprised of soluble coffee solids. The powders are reconstituted on the addition of water to form coffee beverages. It is known for such soluble coffee products to contain amounts of added roast and ground coffee, either as part of the particles in the powder, or by loose admixture. The soluble coffee of the present invention may comprise added roast and ground coffee particles, such from 1 to 25 wt % roast and ground coffee particles and more preferably from 5 to 15 wt % roast and ground coffee particles.

Preferably, by total weight of the ingredients, the composition comprises from 10 to 15 wt % of the soluble coffee.

The ingredients include a non-protein creamer. A creamer ingredient is one which provides a fat component. A fine distribution of small globules of the fat in the final beverage have a whitening effect on the appearance of the beverage which is desirable to the consumer. This is intended to emulate the effect of adding milk to a beverage where the dairy fats achieve the same effect. The fat in a non-dairy creamer is generally a vegetable fat, such as palm oil, palm kernel oil or hydrogenated coconut oil. Such a creamer is also generally formulated to include a range of stabilisers and emulsifiers to achieve and stabilise the desired fine distribution of fat globules.

A dairy creamer contains dairy proteins such as whey and casein. These provide a protein source to the beverage and also stabilise the fat in solution. Non-dairy creamer often contains sodium caseinate and may contain another protein source. However, the present disclosure relies upon the use of a non-protein creamer. That is, the creamer powder is substantially and preferably entirely free of protein. By substantially protein free it is meant that there is less than 0.5 wt % protein, more preferably less than 0.1 wt % protein present in the creamer, more preferably only trace (in the regulatory sense) and most preferable no protein present. Accordingly, the non-protein creamer used in the present disclosure contains as a primary ingredient a source of vegetable fat, together with emulsifiers and stabilisers. Optionally the creamer may comprise glucose syrup to help capture the emulsion in a dry form. A sweetener (such as sucrose) can optionally be present. Exemplary recipe details for a non-protein creamer are provided below.

Preferably the non-protein creamer comprises a vegetable oil and one or more ingredients selected from thickeners, acidity regulators, buffering agents, emulsifiers and stabilisers.

Preferably, by total weight of the ingredients, the composition comprises from 10 to 45 wt % of the non-protein creamer.

The ingredients include a plant-based powder selected from one or more powders of oat, coconut, soy and almond. Preferably the plant-based powder includes just one of these powder-types. Providing a single protein source is advantageous from a marketing perspective, but also minimise the risks associated with a range of allergens. Preferably the plant-based powder is a flour. As used herein, the term flour means a finely divided powder obtained by milling a material from the stated source. A flour is therefore a subset of the broader term powder which may encompass small amounts of associated additives, such as stabilisers, or be used to refer to treated flour compositions.

Accordingly, an oat flour is obtained by the milling of oats or a fraction thereof. The oat flour may, optionally, have been treated by enzymes which would mean that commercially it might be referred to as an oat extract or oat based powder. Coconut powder is typically a coconut milk powder. While this is obtained from coconut milk, it typically contains additives to help allow it to be spray-dried. It is most preferred that the plant-based powder is an oat flour.

Preferably, by total weight of the ingredients, the composition comprises from 1 to 40 wt % of the plant-based powder, preferably 5-12 wt %. This is the total amount present of all protein sources. It should be appreciated that, although the plant-based powder ingredients are referred to as a protein source, the actual plant-based powder content may not be especially high. For example, oat flour contains about 17% protein.

The plant-based powder is provided to act as the protein source expected with a non-dairy creamer. However, unlike a conventional creamer, the inventors have found that the plant-based powder can be provided as a separate powder in the formulation without compromising the final beverage quality. The plant-based powder is desirably provided in a pure form which has not been mixed with plant foreign ingredients, other than potentially some processing aids.

Preferably the plant-based powder is essentially the sole protein source. That is, apart from potentially unavoidable trace amounts in the other ingredients, the only protein is provided by the plant-based powder source. For example, at least 95%, more preferably at least 98% and most preferably 100% of the protein is from the plant-based powder. In addition, as noted above, preferably the composition contains only a single plant-based powder type. Accordingly, unlike known prior art compositions, the composition contains a relatively large amount of a single protein source, such as 5 to 12 wt % of oat flour. This is advantageous from a marketing perspective, but also with a view to reducing the complexity of the product recipe and nutritional information.

A ratio by weight of the non-protein creamer powder to plant-based powder is at least 1:3. This ratio has been found to be necessary to minimise the risk that the powder forms clumps or sediment in the beverage. It is considered that the associated emulsifiers and stabilisers in the non-protein creamer help to stabilise the plant-based powder particles. Preferably the ratio by weight of the non-protein creamer powder to plant-based powder is at least 3:1, preferably from 3:1 to 8:1 and most preferably from 3:1 to 4:1. The lower thresholds of the range (i.e. more plant-based powder) are required to ensure that there are sufficient stabilisers from the creamer component. For the higher thresholds (i.e. less plant-based powder) there is less plant-based powder present, so the benefits associated with providing the protein source are significantly reduced. The range of 3:1 to 4:1 provides an excellent balance of product stability and sufficient protein content in the composition.

Advantageously the composition of the present invention can be dairy-free and suitable for vegan consumers since it is plant-based. Moreover, since the composition is just a mixture of the powder ingredients, it is possible for the final composition to be prepared without contaminating significant pieces of equipment, such as a spray-dryer, with any plant-derived allergens. The invention provides for a whitened coffee beverage which does not have undesirable sedimentation and provides the consumers expected beverage experience without any undesirable compromises. It is surprising that these benefits can be achieved by simple admixture of the plant-based powder with the other ingredients (i.e. not incorporating it in a combined spray-dried powder obtained from a combined liquid mixture).

In particular, it is believed that the emulsifiers and stabilisers in the non-protein creamer help to stabilise the particles in the plant-based flour, helping them to remain suspended and dispersed. In addition, the soluble coffee particles may act as physical spacers for the flour particles helping to reduce the opportunities for lump formation on reconstitution in a beverage medium. Accordingly, the three component composition achieves a good product quality, despite the plant-based powder being provided as a separate component.

Other ingredients which may be present in the composition include sweeteners and, in particular sugar. As with the soluble coffee, it is believed that the inclusion of sugar in the composition may act as a physical spacer, helping to reduce the risk of the flour particles clumping and leading to sedimentation.

Preferably, when present and by total weight of the ingredients, the composition comprises up to 75% sugar, such as from 25 to 75% sugar, preferably 40 to 60 wt % of the sugar. This is the amount of sugar present as a separate powder ingredient in the mixture and does not include any sugar or sugars which may be present in the other ingredients.

The composition may comprise hydrocolloids, such as xanthan gum, gellan gum or sodium carboxymethylcellulose (CMC) or a mixture thereof. Xanthan gum is a particularly effective stabilise for the composition which can be included in small amounts without compromising the beverage qualities (especially flavour). Xanthan gum may be included in an amount of from 0.08-0.25% of the composition. CMC may be used instead in an amount of from 0.45 to 0.6%. If xanthan gum and CMC are used together then preferably the ratio is from 1:3 to 1:4 of xanthan gum to CMC.

The composition may further comprise a foam-boosting ingredient comprising at least 1 ml/g of trapped gas. Such an ingredient is well known in the art and may also be known as a foaming agent or a foam booster. It is known for such ingredients to contain from 1 to 10 ml/g, preferably from 2-5 ml/g of trapped gas (all measured at ambient pressure). Preferably the foam-boosting ingredient is present in an amount of from 1 to 20 wt % by total weight of the ingredients. The presence of such an ingredient is especially preferred for cappuccino formulations (compared to latte formulations) where a foam is desired on the beverage.

The plant-based powder may be provided as a native ingredient (i.e. unprocessed) or it may, where appropriate, be at least partially hydrolysed. The hydrolysation affects how the plant-based powder reacts when added to water, including the likelihood of clump formation and dispersion properties, as well as viscosity increases over time as starch granules swell (i.e. hydrolysed starch granules will swell less or not at all). The requirement to hydrolyse will depend on the nature of the plant-based powder in question. Hydrolysation can be performed with water treatment, optionally in the presence of an enzyme. Preferably the plant-based powder is at least partially hydrolysed and optionally fully hydrolysed. A preferred way to provide a partially hydrolysed plant-based powder is to provide a mixture of hydrolysed (i.e. fully hydrolysed) plant-based powder and native plant-based powder.

Hydrolysation is particularly a consideration for the starch-rich oat flour ingredient. Preferably the plant-based powder is oat flour and wherein a ratio of pre-hydrolysed oat flour to native oat flour is from 5:1 to 3:1. The inventors have surprisingly found that such a ratio provides a composition where the oat flour readily disperses, but also where the beverage forms a stable and reproducible foam. The additional inclusion of a foaming agent with such a formulation provides a cappuccino-type beverage appearance.

According to a preferred embodiment, there is provided composition for forming a beverage, the composition comprising a mixture of powder ingredients, the ingredients comprising:
i) soluble coffee;
ii) a non-protein creamer; and
iii) oat flour;
wherein a ratio by weight of the non-protein creamer powder to oat flour is at least 3:1.

According to a further aspect there is provided a method of forming the composition as described herein, the method comprising dry-mixing together the powder ingredients.

Optionally, the method further comprises granulating or agglomerating the mixture of powder ingredients. This provides an agglomerated or granulated beverage composition which is another aspect of the invention.

According to another aspect there is provided a method of forming a beverage, the method comprising mixing the composition as described herein with a beverage medium. Preferably the beverage medium is water at a temperature of from 80 to 95° C.

According to a further aspect there is provided a creamer composition comprising a mixture of powder ingredients, the ingredients comprising:
i) a non-protein creamer; and
ii) a plant-based powder selected from one or more of oat powder, coconut powder, soy powder and almond powder;
wherein a ratio by weight of the non-protein creamer powder to plant-based powder is at least 1:3. All elements described herein in relation to the first aspect can be freely combined with this further aspect. For example, the plant-based powder is preferably oat flour.

### EXAMPLES

Studies were carried out to examine the dispersibility of different oat powders in hot water and the stability of the oat powder solutions. Under certain circumstances partial gelatinization of starch resulted in lumps (poor dispersibility) and therefore sedimentation occurred (instability).

The following compositions were tested:

| Recipe | Observations |
|---|---|
| Non-protein creamer 30% | Minimal lumps and |
| Coffee 13% | stable beverage |
| Sugar 52% | |
| Oat flour 5% | |
| Non-protein creamer 25% | Small lumps and |
| Coffee 13% | minor sediment |
| Sugar 52% | |
| Oat flour 10% | |
| Non-protein creamer 20% | Some lumps and |
| Coffee 13% | sediment |
| Sugar 52% | |
| Oat flour 15% | |
| Non-protein creamer 15% | Larger lumps and |
| Coffee 13% | powdery sediment |
| Sugar 52% | |
| Oat flour 20% | |
| Non-protein creamer 10% | Larger lumps and |
| Coffee 13% | powdery sediment |
| Sugar 52% | |
| Oat flour 25% | |

In separate tests the stabilisers provided in the NPC were tested as discrete additives. Surprisingly, the stability benefits of the NPC were not observed for such additions. Moreover, oat flour in isolation from the NPC did not deliver an appealing product from an appearance and texture point of view due to the technical challenges mentioned above, as well as mouthfeel can be too viscous and slimy. Moreover from a taste perspective, it is perceived as having overpowering oat/cereally notes. All these have been improved as part of the development.

The invention will now be described further in relation to the following non-limiting examples.

An exemplary composition was provided having the following composition:

| Ingredient | % of dry composition |
|---|---|
| Sugar | ~20 |
| Instant Coffee | 10-15 |
| Booster | ~15 |
| Non-protein creamer | ~40 |
| Hydrolysed oat flour | 10-15 |
| Xanthan gum | <1 |
| Flavours | ~1 |
| Salt | <1 |
| Total | 100 |

This was found to provide a desirable cappuccino beverage with a good foam, resembling the quality of a conventional cappuccino product.

An exemplary non-protein creamer is provided below:

| Ingredient | % of dry composition |
|---|---|
| Glucose syrup | 60-65 |
| Hydrogenated palm kernel oil | ~30 |
| E1450 | ~2 |
| Sugar | ~2 |
| Stabiliser additives E330i, | The balance |
| E452i, E466, E551 | |

Unless otherwise stated, all percentages herein are by weight.

Although preferred embodiments of the invention have been described herein in detail, it will be understood by those skilled in the art that variations may be made thereto without departing from the scope of the invention or of the appended claims.

1. A composition for forming a beverage, the composition comprising a mixture of powder ingredients, the ingredients comprising:
i) soluble coffee;
ii) a non-protein creamer; and
iii) oat flour, the oat flour comprising a mixture of pre-hydrolyzed oat flour and unprocessed oat flour;
wherein a ratio by weight of the non-protein creamer powder to the oat flour is at least 3:1,
wherein 100% of the protein present in the composition is from the plant-based powder, and
wherein a ratio of pre-hydrolysed oat flour to unprocessed oat flour is from 5:1 to 3:1.

2. (canceled)

3. The composition according to claim 1, wherein the ratio by weight of the non-protein creamer powder to the oat flour is from 3:1 to 8:1.

4. The composition according to claim 1, wherein the ingredients further comprise sugar.

5. The composition according to claim 1, wherein the ingredients comprise by total weight of the ingredients:
from 10 to 15 wt % of the soluble coffee; and/or
from 10 to 45 wt % of the non-protein creamer; and/or
from 40 to 60 wt % of sugar; and/or
from 1 to 40 wt % of the oat flour.

6. The composition according to claim 1, wherein the ingredients further comprise a foam-boosting ingredient comprising at least 1 ml/g of trapped gas.

7. The composition according to claim 6, wherein the foam-boosting ingredient is present in an amount of from 1 to 20 wt % by total weight of the ingredients.

8. The composition according to claim 1, wherein the soluble coffee is a spray-dried or freeze-dried coffee powder.

9. The composition according to claim 1, wherein the non-protein creamer comprises a vegetable oil and one or more ingredients selected from thickeners, acidity regulators, buffering agents, emulsifiers and stabilisers.

10.-13. (canceled)

14. A method of forming the composition according to claim 1, the method comprising dry-mixing together the powder ingredients.

15. The method according to claim 14, wherein the method further comprises granulating or agglomerating the mixture of powder ingredients.

16. An agglomerated or granulated beverage composition obtainable by the method of claim 15.

17. A method of forming a beverage, the method comprising mixing the composition according to claim 1 with a beverage medium.

18. The composition according to claim 1, wherein the ratio by weight of the non-protein creamer powder to the oat flour is from 3:1 to 4:1.

19. The composition according to claim 1, wherein the non-protein creamer comprises a fat component, glucose syrup, an emulsifier, and a stabilizer.

20. The composition according to claim 1, wherein the ingredients comprise by total weight of the ingredients:
from 10 to 15 wt % of the soluble coffee;
from 10 to 45 wt % of the non-protein creamer;
from 25 to 75 wt % of sugar; and
from 1 to 15 wt % of the oat flour.

21. The composition according to claim 1, wherein the soluble coffee is a spray-dried or freeze-dried coffee powder and contains roast and ground coffee particles.

22. The composition according to claim 1, wherein the soluble coffee comprises 1 to 25 wt. % roast and ground coffee particles.
